(19) United States
(12) Patent Application Publication
(10) Pub. No.: US 2006/0166684 A1
(43) Pub. Date: Jul. 27, 2006

(54) GPS coordinates downloaded to GPS enabled cell phone in response to information request

(76) Inventors: Jeyhan Karaoguz, Irvine, CA (US); James D. Bennett, San Clemente, CA (US)

Correspondence Address: GARLICK HARRISON & MARKISON LLP, P.O. BOX 160727, AUSTIN, TX, 78716-0727, US

(21) Appl. No.: 11/069,357

(22) Filed: Mar. 1, 2005

Related U.S. Application Data
(60) Provisional application No. 60/647,231, filed on Jan. 26, 2005.

(51) Int. Cl. H04B 7/185

(52) U.S. Cl. 455/457

(57) ABSTRACT

A wireless terminal transmits an information request regarding a business via a supporting wireless network infrastructure. The wireless terminal receives an information response via the supporting wireless network infrastructure that includes information regarding the business and the GPS coordinates of the business. The wireless terminal determines its location coordinates. The wireless terminal displays an indication of the relative position of the wireless terminal with respect to the business. The wireless terminal may access a map segment according to the location coordinates of the wireless terminal and to the GPS coordinates of the business and display the map segment along icons that represent the wireless terminal and the business. These icons are displayed on the map segment at locations corresponding to their location coordinates.

### CROSS REFERENCE TO RELATED APPLICATION

This application claims priority to U.S. Provisional Patent Application Ser. No. 60/647,231, filed Jan. 26, 2005, which is incorporated herein by reference for all purposes.

### BACKGROUND

1. Field of the Invention

The present invention relates generally to wireless communications; and more particularly to operations relating to the location/mobility of a wireless terminal.

2. Background of the Invention

Communication systems are well known. Communication systems include both wired communication systems and wireless communication systems. Wired communication systems include the Public Switched Telephone Network (PSTN), Wide Area Networks (WANs), Local Area Networks (LANs), and other networks that use wired or optical media for the transmission of data. Wireless communication systems include cellular telephone systems, satellite communication systems, Wireless Wide Area Networks (WWANs), Wireless Local Area Networks (WLANs), Wireless Personal Area Networks (WPANs), and other networks that employ a wireless link between a serviced terminal and a network infrastructure. Of course, many communications are serviced using a combination of wireless communication systems and wired communication systems.

Mobile navigation systems for automotive applications have become quite popular. With these automobile based navigation systems, an optical media is employed to store map information used for navigation purposes, e.g., road information, address information, etc. Such map information is quite voluminous, often requiring many Compact Disk Read Only Memories (CD-ROMs) to store. Hand-held Global Positioning System (GPS) terminals have been available for some time and are commonly used. These hand-held GPS terminals typically have minimal storage capacity for maps making them have limited functionally for navigation purposes.

Wireless terminals have historically been fairly reduced functionality devices. While they adequately supported voice communications, they did little to support data communications and other types of services. Because of their mobility and their increasing functionality it would be desirable for wireless terminals to support Internet commerce and other types of commerce in an intelligent manner. Thus, there is a need in the art for techniques for utilizing the wireless terminal for business commerce purposes commensurate with their mobility.

### SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a system diagram illustrating a wireless communication system that operates according to the present invention;

FIG. 2 is a flow chart illustrating a method for operating a wireless terminal according to an embodiment of the present invention;

FIG. 3A is a partial flow chart illustration operation according to the present invention in transmitting a business order by a wireless terminal;

FIG. 3B is a flow chart illustrating operation according to the present invention in servicing a charge query by a wireless terminal;

FIG. 4 is a flow chart illustrating operation according to the present invention in downloading a premises map by a wireless terminal;

FIG. 5 is a partial flow diagram illustrating “compass mode” operation according to the present invention;

FIG. 6A is a block diagram representing a display of a wireless terminal operating according to the present invention;

FIG. 6B is a block diagram representing a display of a wireless terminal operating according to the present invention and when in a compass mode;

FIG. 7 is a block diagram representing a display operating according to another embodiment of the present invention;

FIG. 8 is a block diagram illustrating a wireless terminal constructed according to the present invention; and

FIG. 9 is a system diagram illustrating a system that may be used according to the present invention.

### DETAILED DESCRIPTION OF THE INVENTION

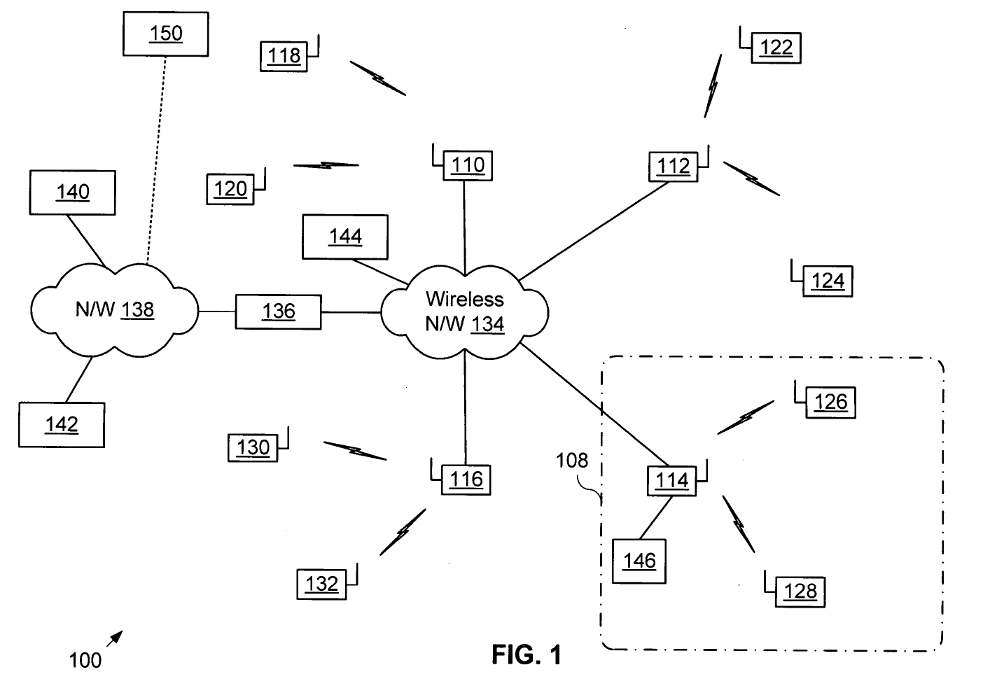

FIG. 1 is a system diagram illustrating a wireless communication system that operates according to the present invention. The wireless communication system 100 of FIG. 1 includes one or more servicing base stations and/or wireless access points (WAPs) 110, 112, 114, and 116. The reader should understand that the structure of FIG. 1 is used only to convey the principles of the present invention and is not intended to be a detailed description of a cellular wireless communication system, a Wireless Local Area Network (WLAN), a Wireless Wide Area Network (WWAN), or a Wireless Personal Area Network (WPAN).

As is shown, base station/WAP 110 supports wireless terminals 118 and 120 within a respective serving area, e.g., cell, sector, premises, area, etc. Likewise, base station/WAP 112 supports wireless terminals 122 and 124, base station/WAP 114 supports wireless terminals 126 and 128, and base station/WAP 116 supports wireless terminal 130 and 132. The base stations/WAPs 110, 112, 114, and 116 are serviced via network backbone 134 and interface device 136. The interface device 136 couples the wireless backbone network 134 to another network 138. The another network 138 may include a Local Area Network (LAN), a Wide Area Network (WAN), the Internet, or any other type of network that couples the wireless backbone network backbone 134 via the network interface 136 to computers or terminals 140, 142, and 142, one, some or all of which may be map servers. A business 150 may couple to network 138 and include a server, for example.

Generally, operation according to the present invention commences with the wireless terminal 118 transmitting an information request regarding a business, e.g., 150 via a supporting wireless network infrastructure 134 (and 138, in some cases). In response, the wireless terminal 118 receives an information response via the supporting wireless network infrastructure 134/138. The information response may include information regarding the business 150 and the GPS coordinates of the business 150. The wireless terminal 118 may then access a GPS receiver of the wireless terminal 118 to determine location coordinates of the wireless terminal 118. The wireless terminal 118 optionally accesses a map segment corresponding to the location coordinates of the wireless terminal 118 and to the GPS coordinates of the business 150. The wireless terminal 118 then displays an indication on its display of the relative position of the business with respect to the wireless terminal 118. The relative position information is textual and/or graphic.

When the wireless terminal 118 optionally accesses the map segment, the wireless terminal 118 may access onboard memory or other storage, e.g., disk drive, where the map segment is stored. Alternatively, the wireless terminal 118 may transmit a map segment download request and receive the map segment in response thereto. The wireless terminal 118 then displays the map segment on its display. In addition to displaying the map segment, the wireless terminal 118 also displays an icon that represents the wireless terminal 118 and an icon that represents the business 150 on the display. The icon that represents the wireless terminal 118 is displayed on the map segment at a location corresponding to the location coordinates of the wireless terminal 118. Further, the icon that represents the business 150 is displayed at a location on the map segment corresponding to GPS coordinates of the business.

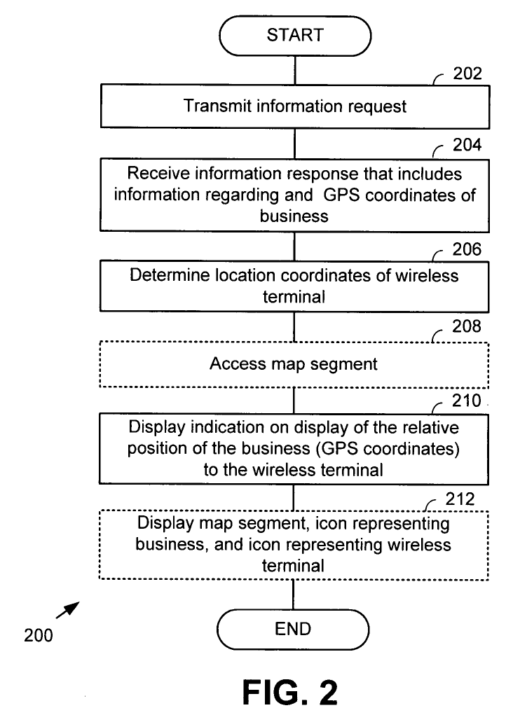

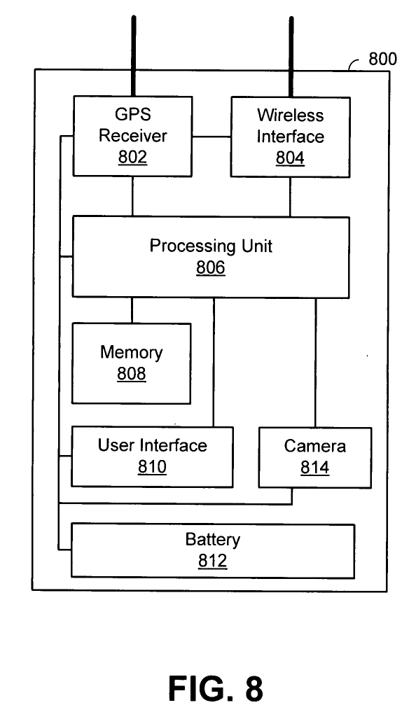

The information regarding the business may be of various types of information. For example, the information may be the address of the business, at least one product offered by the business, at least one service offered by the business, at least one food item offered by the business, an identity of another business located proximate to the business, and an identity of another business located proximate to the wireless terminal, among others. The operation of the wireless communication system 100 and of the wireless terminals 118-132 supported thereby will be described further with reference to FIGS. 2-7 and 9. The structure of the wireless terminals 118-132 will be described further with reference to FIG. 8. Generally, a wireless terminal, e.g., 118 is used to support commerce.

FIG. 2 is a flow chart illustrating a method for operating a wireless terminal according to an embodiment of the present invention. Operation 200 commences with the wireless terminal transmitting an information request regarding a business via a supporting wireless network infrastructure (Step 202). Operation continues with the wireless terminal receiving information response via the supporting wireless network infrastructure and its wireless interface (Step 204). This information response includes information regarding the business and the GPS coordinates of the business. Then, the wireless terminal accesses its GPS receiver to determine its location coordinates (Step 206). The wireless terminal then optionally accesses a map segment corresponding to the location coordinates to the wireless terminal and to the GPS coordinates of the business (Step 208). The wireless terminal then displays an indication on its display of the relative position of the business with respect to the wireless terminal (Step 210). The relative position information may be textual and/or graphic.

When the wireless terminal optionally accesses the map segment at step 208, the wireless terminal may display the map segment along with an icon that represents the wireless terminal and an icon that represents the business on its display (Step 212). The icon that represents the wireless terminals is displayed on the map segment at a location corresponding to the location coordinates to the wireless terminal. Likewise, the icon that represents the business is displayed at a location corresponding to the GPS coordinates of the business. With such operations complete, the user of the wireless terminal may navigate to the location of the business.

The information regarding the business that is received by the wireless terminal at Step 204 may include, for example, an address of the business, at least one product offered by the business, at least one service offered by the business, at least one food item offered by the business, an identity of another business located proximate to the business, and an identity of another business located proximate to a wireless terminal. The information request transmitted at Step 202 may be based upon and include a voice request made by the user of the wireless terminal to an operator via the wireless terminal and the supporting wireless network infrastructure. Alternately, the information request may be a voice request received from the user and made to an Interactive Voice Response (IVR) system of a supporting device. Alternatively, the information request may be a keypad input request, a cursor input request, or a browser input request, among other information type requests.

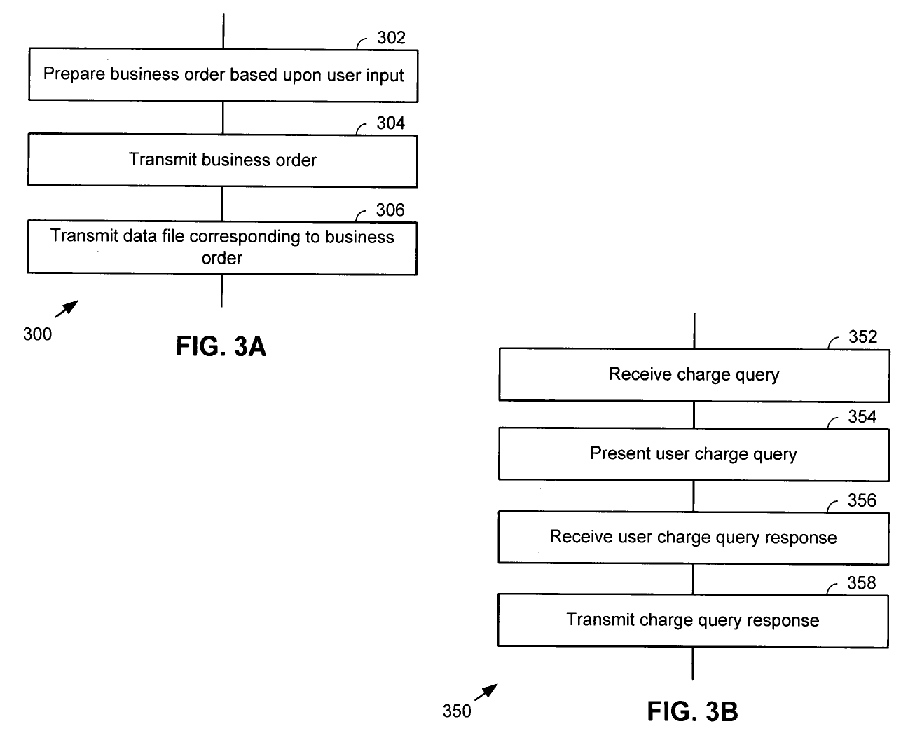

FIG. 3A is a partial flow chart illustration operation according to the present invention in transmitting a business order by a wireless terminal. Such operation 300 includes preparing a business order based upon user input received via a user interface (Step 302). The operations 300 of FIG. 3A would typically be performed in addition to the operations 200 of FIG. 2. The business order may be prepared based upon one of various types of user input including a voice request, a keypad input request of the user, a cursor input request of the user, and/or a browser input request of the user. Operation continues in transmitting the business order to the business via the supporting wireless network infrastructure (Step 304), e.g., to business 150 of FIG. 1.

In conjunction with transmitting the business order at Step 304, operation may include transmitting a data file to the business via the supporting wireless network infrastructure (Step 306). In such case, when a data file is transmitted, the business order may include a request to process the data file. The data file may include photographic images, video images, audio recordings, and document files, among other types of information. In such case, for example, when the data file transmitted at Step 306 includes a photographic image or video image, the business order may include a request to create prints of the images and/or to create Compact Disk Read Only Memories (CD-ROMs) or Digital Video Discs (DVDs) that include the photographic images/video images or materials that were made from the photographic images/video images. Photographic images and/or video images may have been captured using the wireless terminal and then prepared for delivery and delivered at Step 306.

Likewise, audio recordings that have been captured by the wireless terminal or otherwise downloaded to the wireless terminal may make up all or a portion of the data file at Step 306. In such case, the business order may include burning a CD-ROM with the audio recordings or otherwise processing the audio recordings. The data file may be a document file and the business order may request that the document file be printed, bound, and prepared for pickup by the user of the wireless terminal, for example. Of course, these are examples only and the reader of the present application will appreciate that the principles of the present invention can be expanded to support many other types of data files and operations by a business there upon.

FIG. 3B is a flow chart illustrating operation according to the present invention in servicing a charge query by a wireless terminal. The operations 350 of FIG. 3B may be performed between Steps 202 and 204 of FIG. 2. Operation 350 commences with the wireless terminal receiving a charge query via the supporting wireless network infrastructure (Step 352). In response to receiving the charge query at Step 352, the wireless terminal presents a user charge query to the user of the wireless terminal via a user interface (Step 354). The user terminal then receives a user charge query response via the user interface (Step 356). Then finally, the wireless terminal prepares and transmits a charge query response via the supporting wireless network to a servicing device (Step 358). The information response transmitted to the wireless terminal at Step 204 includes the GPS coordinates of the business only upon a favorable charge query response that was transmitted at Step 356. Thus, if the user is unwilling to pay for the GPS coordinates and indicates as such the GPS coordinates of the business will not be downloaded to the wireless terminal.

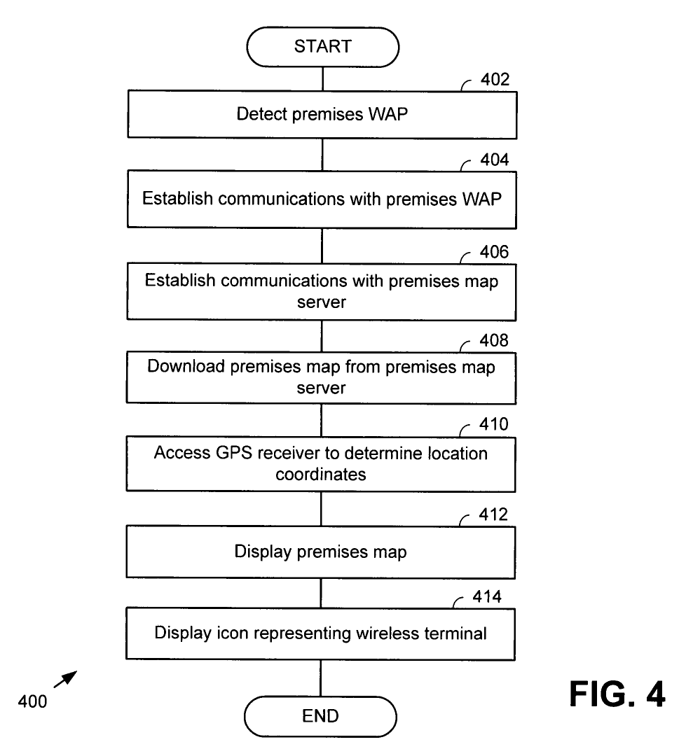

FIG. 4 is a flow chart illustrating operation according to the present invention in downloading a premises map by a wireless terminal. The Operations 400 of FIG. 4 may be performed in addition to, or in conjunction with the operations 200 of FIG. 2. Operation 400 commences with the wireless terminal detecting the presence of a premises WAP (Step 402). In one particular operation, the wireless terminal detects the premises WAP upon entering a serviced premises by receiving a beacon signal broadcast by the premises WAP. Operation continues with the wireless terminal establishing wireless communications with the premises WAP (Step 404). Then, the wireless terminal establishes communications with a premises map server via the premises WAP (Step 406). As was described with reference to FIG. 1, the map server may couple to a LAN that services the premises. Alternately, the map server may be coupled to the premises WAP via multiple coupling networks. Operation continues with the wireless terminal downloading a premises map from the premises map server via the premises WAP (Step 408). The wireless terminal may then access its GPS receiver to determine its location coordinates (Step 410). The wireless terminal then displays the premises map on its display (Step 412). In the embodiment of FIG. 4, the wireless terminal may also display an icon representing itself on the premises map (Step 414).

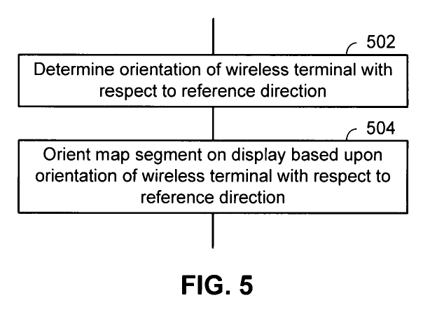

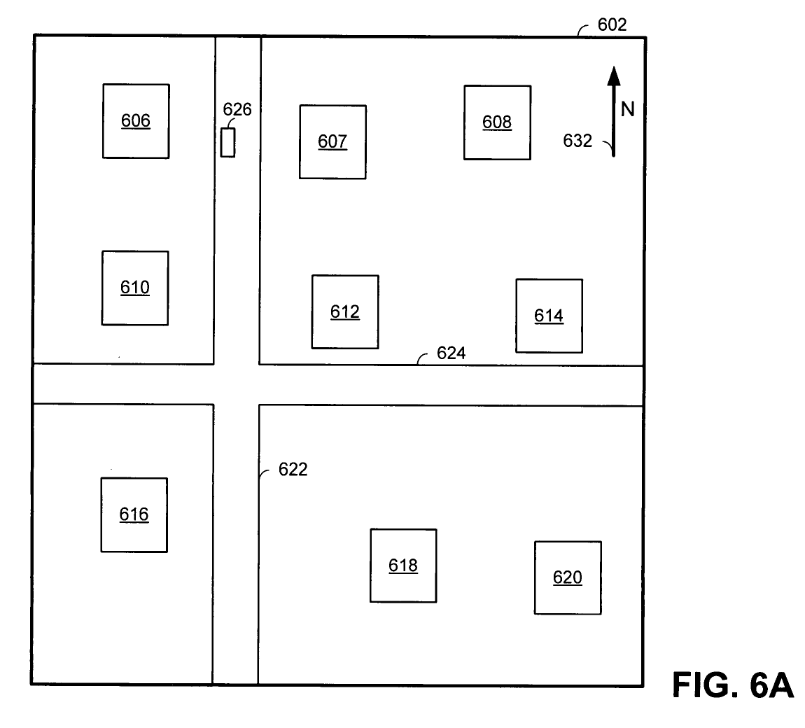

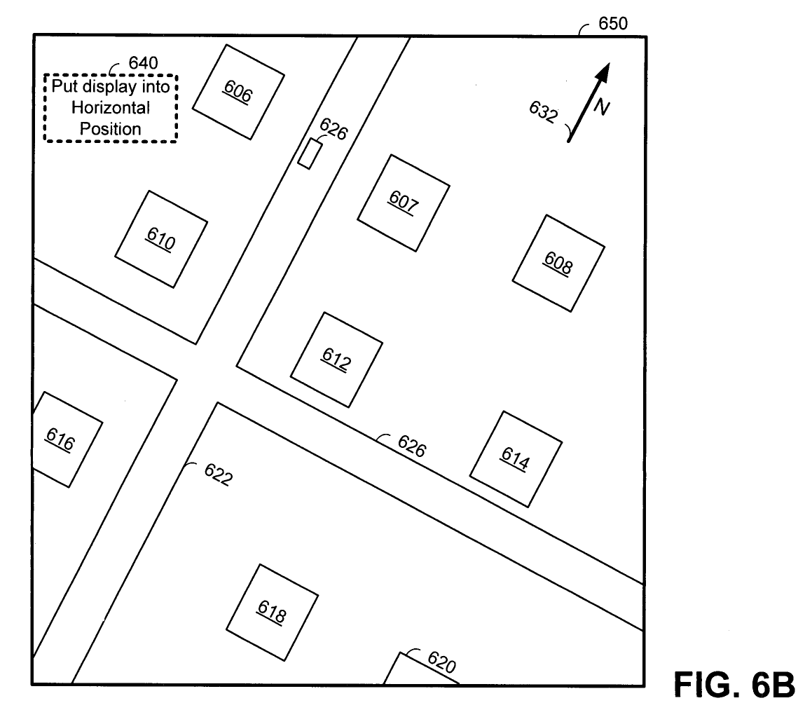

FIG. 5 is a partial flow diagram illustrating “compass mode” operations according to the present invention. With compass mode operations, the wireless terminal determines an orientation of the wireless terminal with respect to a reference direction (Step 502). This reference direction may be magnetic north, actual north, or another reference direction. Typically, this reference direction is determined based upon a magnetic compass, access of the GPS receiver, or by another mechanism supported by the wireless terminal. Based upon the determined orientation, the wireless terminal orients the map segment on the display based upon the orientation of the wireless terminal so that the map segment is displayed in a correct orientation with reference to mapped physical features (Step 504). The operation of Steps 502 and 504 may be performed concurrently with Step 212 of FIG. 2 or with steps 412 and 414 of FIG. 4. FIGS. 6A and 6B illustrate further the teachings of the compass mode feature of FIG. 5.

FIG. 6A is a block diagram representing a display of a wireless terminal operating according to the present invention. As shown in FIG. 6A, the display 602 of the wireless terminal has displayed there upon a map segment along with icons that represent the wireless terminal 626. Shown in the map segment are geographic entities 606, 607, 608, 610, 612, 614, 616, 618, and 620 (referred to hereinafter as 606-620), one of which may be a desired destination. These geographic entities 606-620 may be buildings, parks, landmarks, parking areas, or other geographic features identified within the map segment. The wireless terminal may identify or provide additional information with regard to these geographic features 606-620. The actual size and shape of these geographic features 606-620 may be indicated in more detail than is shown in FIG. 6A. The map segment shown on display 602 also shows roads 622 and 624. The wireless terminal 626 is shown as an icon in the shape of an automobile because it is residing upon road 622. The map segment is shown in one orientation with a reference direction 632 which in the example of FIG. 6A is the direction north.

FIG. 6B is a block diagram representing a display of a wireless terminal operating according to the present invention and when in a compass mode. As shown in FIG. 6B, the map segment on display 650 has been oriented based upon the orientation of the tracking wireless terminal with respect to a reference direction so that the geographic features 606-620 of the map segment are displayed in a correct orientation with reference to the orientation of the wireless terminal. As is shown, the north vector 632 is not oriented vertically on the display 650. Thus, as compared to the display 602 of FIG. 6A, the tracking wireless terminal resides in a different physical orientation with respect to the reference direction 632. The teachings illustrated in FIGS. 6A and 6B may be easily extended to any particular orientation of the tracking wireless terminal. Based upon the particular orientation of the wireless terminal, the reference numerals and information relating to the geographical features may be oriented in different directions for easier access by the user of the tracking wireless terminal.

Note that the operations of FIG. 6B work best when a plane of the display orients substantially in parallel to the surface of the earth. In this orientation, a reference direction of the wireless terminal, e.g., a side of the display 650, may most easily be compared to the reference direction 632. Thus, the display 602 may include a warning 640 directing the user to place the display into a horizontal position. With the display 602 in the horizontal position the geographic features 606-620 of the map segment may be most easily displayed in a correct orientation with reference to the orientation of the wireless terminal. With the display 602 not in a horizontal position, two separate operations may be employed. The relative orientation of the wireless terminal with respect to the reference direction may be best estimated and the display 602 updated based upon the best estimate. Alternately, the wireless terminal may use a last valid estimate of the relative orientation of the wireless terminal with respect to the reference direction.

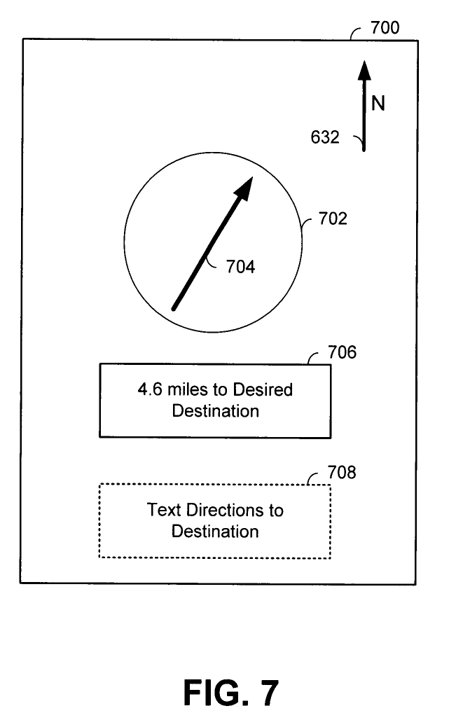

FIG. 7 is a block diagram representing a display operating according to another embodiment of the present invention. The display includes an indication of the relative position of a desired destination, e.g., the business at corresponding GPS coordinates as described with respect to FIGS. 2 and 4. With the particular embodiment illustrated in FIG. 7, a vector 704 contained within a boundary 602 and a distance indication 706 provides the indication. A reference direction 632, e.g., North, may also be provided to the user for additional information. With this information, that is continually updated, a user of the wireless terminal may easily determine the relative position of the wireless terminal to the desired destination. Alternately, or in addition, the display 700 may include thereon textual directions to the intended desired destination. The display of such information would further reduce the download requirements to the wireless terminal from the servicing wireless network.

FIG. 8 is a block diagram illustrating a wireless terminal constructed according to the present invention. As shown in FIG. 8, the wireless terminal 800 includes a GPS receiver 802, a wireless interface 804, a processing unit 806, memory 808, user interface 810, and a battery 812. The components of the wireless terminal 800 are typically contained within a hard case that provides protection from the elements. The wireless interface 804 will have particular structure and functionality based upon the type of the wireless terminal 800. For example, when the wireless terminal 800 is a cellular telephone, the wireless interface 804 will support a corresponding cellular interface standard, e.g., GSM, GPRS, EDGE, UMTS, 1xRTT, 1xEV-DO, 1xEV-DV, etc. The wireless interface 804 of the cellular telephone 804 may also/alternately support WWAN, WLAN, and/or WPAN functionality. When the wireless terminal is a WLAN terminal for example, the wireless interface 804 will support standardized communication according to the IEEE 802.11x group of standards, for example. When the wireless terminal is a WPAN device, the wireless interface 804 would support the Bluetooth interface standard or another WPAN standard such as the 802.15 standard. In any case, the wireless interface 804 may support all or a subset of cellular telephone, WLAN, and WPAN operations.

The processing unit 806 (processing resources) may include any type of processor such as a microprocessor, a digital signal processor, an Application Specific Integrated Circuit (ASIC), or a combination of processing type devices. The processing unit 806 is operable to execute a plurality of software instructions that are stored in memory 808 and downloaded for execution. The processing unit 806 may also include specialized hardware required to implement particular aspects of the present invention. Memory 808 may include SRAM, DRAM, PROM, flash RAM, or any other type of memory capable of storing data and instructions.

A user interface 810 may include a microphone, a speaker, a keypad, a screen, a touch screen, a light, a voice recognition system, an optical recognition system that would authenticate a user's iris, for example, and/or any other type of interface that may be employed in the wireless terminal. In some embodiments, the user interface 810 may include therewith ability to service a headset including microphone and earpiece for the user. In some embodiments of the wireless terminal 800, the user interface 810 is of reduced functionality to minimize the size of the wireless terminal 800. In such case, programming of the wireless terminal 800 may be performed via the wireless interface 804. In such case, the wireless terminal 800 may be small enough to be worn around a child's wrist, around the neck, pinned to the inside of clothing, placed in a pocket, or concealed upon the person. Battery 812 powers the components of the wireless terminal 800.

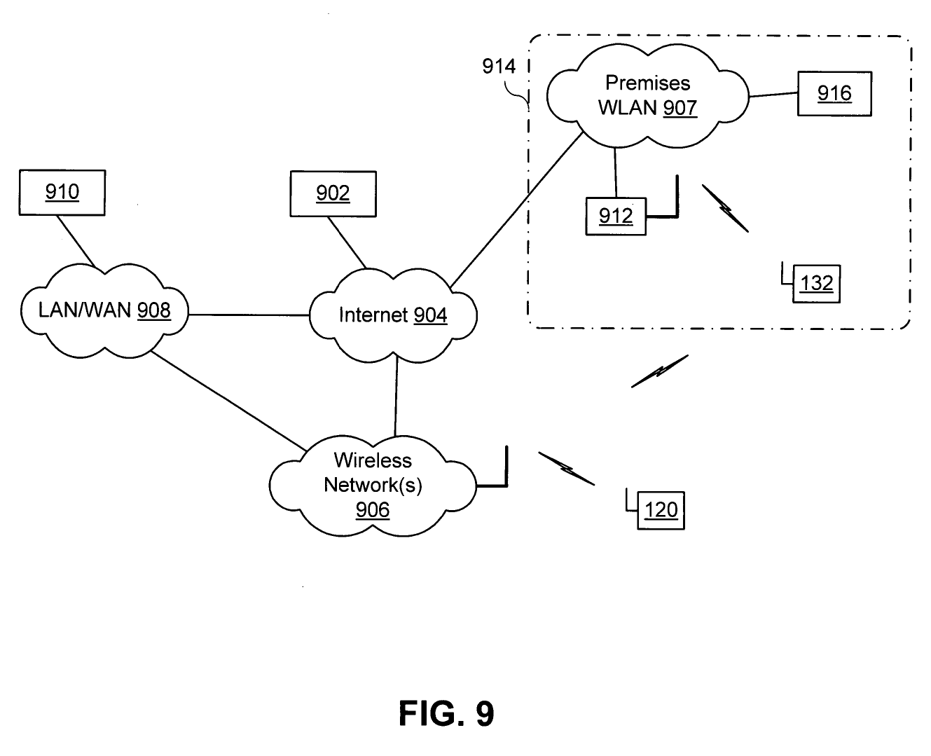

FIG. 9 is a system diagram illustrating a system that may be used according to the present invention. The system of FIG. 9 includes server 902, a server 910, a wireless network 906, Internet 904, LAN/WAN 908, premises WLAN 907, server 916 (a/k/a map server), and WAP 912. The premises WAP 912 services premises 914, e.g., business 150, and supports wireless communications with wireless terminal 132 when located within the premises 914. Wireless network 906 supports wireless communications for both wireless terminal 120 and 132. Wireless network 906 may be a cellular wireless communication system, a WWAN communication system, or another wireless communication system that services areas outside of premises 914.

The system of FIG. 9 may be employed according to the various aspects of the present invention in servicing wireless terminal 120. When wireless terminal 120 desires to receive information regarding a business, e.g., business 150 corresponding to premises 914, it transmits an information request regarding the business 150 via supporting wireless network infrastructure 906 that is received by server/operator 910, for example. The server 910 (and operator coupled thereto) prepares an information response and transmits the information response to the wireless terminal 120. The wireless terminal 120 receives the information response via the supporting wireless network infrastructure 906 and LAN/WAN 908. This information request includes information regarding a business 150 corresponding to premises 150, for example. Map segments may also be downloaded from the server 910.

Other operations of the present invention may be supported by premises WLAN 907, premises WAP 912, and server 916. When wireless terminal 132 enters premises 914, it establishes communications with premises WAP 912. Via premises WAP 912, wireless terminal 132 accesses server 916 via the premises WLAN 907 and WAP 912. Upon this access, the premises server 916 downloads a premises map to wireless terminal 132 for display on the display of the wireless terminal. This premises map will typically include a plurality of points-of-interest located within premises 914. Premises map would also include GPS coordinates respected to the plurality points-of-interest within the premises 914. Further, the map segment may include offers available within premises. For example, if the premises includes a number of stores and is a shopping mall, the premises map may include special offers not otherwise available causing customer/user of wireless terminal 132 to move to particular stores. The wireless terminal having received the map segment of the premises map from the map server, server 916, would be able to receive the special offer.

As one of average skill in the art will appreciate, the term “substantially” or “approximately,” as may be used herein, provides an industry-accepted tolerance to its corresponding term. Such an industry-accepted tolerance ranges from less than one percent to twenty percent and corresponds to, but is not limited to, component values, integrated circuit process variations, temperature variations, rise and fall times, and/or thermal noise. As one of average skill in the art will further appreciate, the terms “communicatively coupled” or “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of average skill in the art will also appreciate, inferred coupling (i.e., where one element is coupled to another element by inference) includes direct and indirect coupling between two elements in the same manner as “operably coupled.” As one of average skill in the art will further appreciate, the term “compares favorably,” as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The invention disclosed herein is susceptible to various modifications and alternative forms. Specific embodiments therefore have been shown by way of example in the drawings and detailed description. It should be understood, however, that the drawings and description thereto are not intended to limit the invention to the particular form disclosed, but on the contrary, the invention is to cover all modifications, equivalents, and alternatives falling within the spirit and scope of the present invention as defined by the claims.

1. A method for operating a wireless terminal comprising:
transmitting an information request regarding a business via a supporting wireless network infrastructure;
receiving an information response via the supporting wireless network infrastructure, the information response including information regarding the business and Global Positioning System (GPS) coordinates of the business;
accessing a GPS receiver of the wireless terminal to determine location coordinates of the wireless terminal;
determining a relative position of the location coordinates of the GPS coordinates of the business to the location coordinates of the wireless terminal; and
displaying on a display of the wireless terminal an indication of the relative position of the business with respect to the wireless terminal.

2. The method of claim 1, further comprising:
accessing a map segment corresponding to the location coordinates of the wireless terminal and to the GPS coordinates of the business; and
displaying the map segment, an icon that represents the wireless terminal, and an icon that represents the business on the display, the icon that represents the wireless terminal displayed on the map segment at a location corresponding to the location coordinates of the wireless terminal, and the icon that represents the business displayed on the map segment at a location corresponding to the GPS coordinates of the business.

3. The method of claim 1, wherein the information regarding the business is selected from the group consisting of at least:
an address of the business;
at least one product offered by the business;
at least one service offered by the business;
at least one food item offered by the business;
an identity of another business located proximate to the business; and
an identity of another business located proximate to the wireless terminal.

4. The method of claim 1, further comprising:
preparing a business order based upon user input received via a user interface; and
transmitting the business order to the business via the supporting wireless network infrastructure.

5. The method of claim 4:
further comprising transmitting a data file to the business via the supporting wireless network infrastructure; and
wherein the business order comprises a request to process the data file.

6. The method of claim 5, wherein the data file is selected from the group consisting of at least:
photographic images;
video images;
audio recordings; and
document files.

7. The method of claim 1, wherein the information request is selected from the group consisting of at least:
a voice request made to an operator;
a voice request made to an Interactive Voice Response (IVR) system;
a keypad input request;
cursor input request; and
a browser input request.

8. The method of claim 1, further comprising:
receiving a charge query via the supporting wireless network infrastructure;
presenting a user charge query via a user interface;
receiving a user charge query response via the user interface;
transmitting a charge query response via the supporting wireless network; and
wherein the information response includes the GPS coordinates of the business only upon a favorable charge query response.

9. The method of claim 1, further comprising:
detecting the entering of a premises serviced by a premises wireless access point;
establishing communications with a premises server; and
downloading information regarding the premises from the premises server via the supporting wireless network infrastructure.

10. A method for operating a wireless terminal comprising:
transmitting an information request regarding a business via a supporting wireless network infrastructure;
receiving an information response via the supporting wireless network infrastructure, the information response including information regarding the business and Global Positioning System (GPS) coordinates of the business;
accessing a GPS receiver of the wireless terminal to determine location coordinates of the wireless terminal;
accessing a map segment corresponding to the location coordinates of the wireless terminal and to the GPS coordinates of the business; and
displaying the map segment, an icon that represents the wireless terminal, and an icon that represents the business on the display, the icon that represents the wireless terminal displayed on the map segment at a location corresponding to the location coordinates of the wireless terminal, and the icon that represents the business displayed on the map segment at a location corresponding to the GPS coordinates of the business.

11. The method of claim 10, wherein the information regarding the business is selected from the group consisting of at least:
an address of the business;
at least one product offered by the business;
at least one service offered by the business;
at least one food item offered by the business;
an identity of another business located proximate to the business; and
an identity of another business located proximate to the wireless terminal.

12. The method of claim 10, further comprising:
preparing a business order based upon user input received via a user interface; and
transmitting the business order to the business via the supporting wireless network infrastructure.

13. The method of claim 12:
further comprising transmitting a data file to the business via the supporting wireless network infrastructure; and
wherein the business order comprises a request to process the data file.

14. The method of claim 13, wherein the data file is selected from the group consisting of at least:
photographic images;
video images;
audio recordings; and
document files.

15. The method of claim 10, wherein the information request is selected from the group consisting of at least:
a voice request made to an operator;
a voice request made to an Interactive Voice Response (IVR) system;
a keypad input request;
cursor input request; and
a browser input request.

16. The method of claim 10, further comprising:
receiving a charge query via the supporting wireless network infrastructure;
presenting a user charge query via a user interface;
receiving a user charge query response via the user interface;
transmitting a charge query response via the supporting wireless network; and
wherein the information response includes the GPS coordinates of the business only upon a favorable charge query response.

17. The method of claim 10, further comprising:
determining an orientation of the wireless terminal with respect to a reference direction; and
orienting the map segment on the display based upon the orientation of the wireless terminal so that the map segment is displayed in a correct orientation with reference to mapped physical features.

18. The method of claim 10, further comprising:
detecting the entering of a premises serviced by a premises wireless access point;
establishing communications with a premises map server; and
downloading a premises map from the premises map server via the supporting wireless network infrastructure.

19. The method of claim 20, further comprising:
detecting the entering of a premises serviced by a premises wireless access point;
establishing wireless communications with the premises wireless access point;
establishing communications with a premises map server via the premises wireless access point; and
downloading a premises map from the premises map server via the premises wireless access point.

20. A wireless terminal comprising:
a wireless interface;
a user interface including a display;
a Global Positioning System (GPS) receiver; and
a processing unit communicatively coupled to the wireless interface, the user interface, and the GPS receiver and operable to:
transmit an information request regarding a business via the wireless interface and a supporting wireless network infrastructure;
receive an information response via the wireless interface and the supporting wireless network infrastructure that includes information regarding the business and GPS coordinates of the business;
access the GPS receiver to determine location coordinates of the wireless terminal;
determine a relative position of the location coordinates of the GPS coordinates of the business to the location coordinates of the wireless terminal; and
display on the display an indication of the relative position of the business with respect to the wireless terminal.

21. The wireless terminal of claim 20, wherein the processing unit is further operable to:
access a map segment corresponding to the location coordinates of the wireless terminal and to the GPS coordinates of the business; and
display an icon that represents the wireless terminal and an icon that represents the business, the icon that represents the wireless terminal displayed on the map segment at a location corresponding to the location coordinates of the wireless terminal, and the icon that represents the business displayed on the map segment at a location corresponding to the GPS coordinates of the business.

22. The wireless terminal of claim 20, wherein the information regarding the business is selected from the group consisting of at least:
an address of the business;
at least one product offered by the business;
at least one service offered by the business;
at least one food item offered by the business;
an identity of another business located proximate to the business; and
an identity of another business located proximate to the wireless terminal.

23. The wireless terminal of claim 20, wherein the processing unit is further operable to:
prepare a business order based upon user input received via the user interface; and
transmit the business order to the business via the supporting wireless network infrastructure.

24. The wireless terminal of claim 23, wherein:
the processing unit is further operable to transmit a data file to the business via the supporting wireless network infrastructure; and
the business order comprises a request to process the data file.

25. The wireless terminal of claim 24, wherein the data file is selected from the group consisting of at least:
photographic images;
video images;
audio recordings; and
document files.

26. The wireless terminal of claim 20, wherein the information request is selected from the group consisting of at least:
a voice request made to an operator;
a voice request made to an Interactive Voice Response (IVR) system;
a keypad input request;
cursor input request; and
a browser input request.

27. The wireless terminal of claim 20, wherein the processing unit is further operable to:
receive a charge query via the wireless interface and the supporting wireless network infrastructure;
present a user charge query via the user interface;
receive a user charge query response via the user interface;
transmit a charge query response via the wireless interface and the supporting wireless network; and
wherein the information response includes the GPS coordinates of the business only upon a favorable charge query response.

28. The wireless terminal of claim 20, wherein the processing unit is further operable to:
determine an orientation of the wireless terminal with respect to a reference direction; and
orient the map segment on the display based upon the orientation of the wireless terminal so that the map segment is displayed in a correct orientation with reference to mapped physical features.

29. The wireless terminal of claim 20, wherein the processing unit is further operable to:
detect, via the wireless interface, the entering of a premises serviced by a premises wireless access point;
establish communications with a premises map server via the wireless interface; and
download a premises map from the premises map server via the wireless interface and the supporting wireless network infrastructure.

30. The wireless terminal of claim 20, wherein the processing unit is further operable to:
detect, via the wireless interface, the entering of a premises serviced by a premises wireless access point;
establish, via the wireless interface, wireless communications with the premises wireless access point;
establish communications with a premises map server via the wireless interface and the premises wireless access point; and
download a premises map from the premises map server via the premises wireless access point and the wireless interface.
